(19) United States
(12) Patent Application Publication
(10) Pub. No.: US 2018/0097605 A1
(43) Pub. Date: Apr. 5, 2018

(54) Resource Pre-Allocation and Opportunistic Full-Duplex Downlink Transmission for Wireless Communication

(71) Applicant: Intel IP Corporation, Santa Clara, CA (US)

(72) Inventors: Alexander W. Min, Portland, OR (US); Dave Cavalcanti, Beaverton, OR (US); Shahrnaz Azizi, Cupertino, CA (US); Minyoung Park, Portland, OR (US)

(21) Appl. No.: 15/282,392

(22) Filed: Sep. 30, 2016

(51) Int. Cl. H04L 5/14; H04W 72/04; H04L 5/00

(52) U.S. Cl. CPC H04L 5/14; H04W 72/042; H04W 72/0446; H04W 72/0413; H04L 5/0007

(57) ABSTRACT

This disclosure describes methods, apparatus, and systems related to resource pre-allocation and opportunistic full-duplex downlink transmissions for wireless communication. A device may determine a wireless communication sub-channel for uplink transmissions. The device may cause to send a full-duplex trigger frame including resource pre-allocation instructions for the sub-channel. The device may receive an uplink frame on the sub-channel. The device may receive first downlink data. The device may determine if an estimated downlink transmission time is less than an estimated residual uplink transmission time. The device may cause to send the first downlink data upon determining that the estimated downlink transmission time is not less than the estimated residual uplink transmission time. The device may cause to send the first downlink data and second downlink data upon determining that the estimated downlink transmission time is less than the estimated residual uplink transmission time.

### TECHNICAL FIELD

This disclosure generally relates to systems and methods for wireless communications and, more particularly, to resource pre-allocation in wireless communications.

### BACKGROUND

Wireless devices are becoming widely prevalent and are increasingly requesting access to wireless channels. A next generation WLAN, IEEE 802.11 or High-Efficiency WLAN (HEW) utilizes Orthogonal Frequency-Division Multiple Access (OFDMA) in channel allocation. Communication channels may be comprised of one or more sub-channels, where individual sub-channels may be susceptible to interference from adjacent devices.

### BRIEF DESCRIPTION OF THE DRAWINGS

FIG. 1 depicts a network diagram illustrating an example network environment of an illustrative OFDMA resource pre-allocation and an opportunistic full-duplex downlink transmission system, according to one or more example embodiments of the disclosure.

FIG. 2 depicts a diagram illustrating asynchronous pre-allocation-based uplink frame transmissions, according to one or more example embodiments of the disclosure.

FIG. 3 depicts a diagram illustrating solicited and pre-allocated unsolicited uplink frame transmissions, according to one or more example embodiments of the disclosure.

FIG. 4 depicts a diagram illustrating resource pre-allocation in a non-overlapping manner in the presence of solicited uplink frame transmissions, in accordance with one or more example embodiments of the present disclosure.

FIG. 5 depicts a diagram illustrating resource pre-allocation in a non-overlapping manner in the absence of solicited uplink frame transmissions, in accordance with one or more example embodiments of the present disclosure.

FIG. 6 depicts a flow diagram of an illustrative process for an illustrative OFDMA resource pre-allocation system, in accordance with one or more example embodiments of the present disclosure.

FIG. 7 depicts a diagram illustrating opportunistic full-duplex downlink transmission based on a residual uplink transmission time, in accordance with one or more example embodiments of the present disclosure.

FIG. 8 depicts a diagram illustrating opportunistic full-duplex downlink transmission based on a residual uplink transmission time, in accordance with one or more example embodiments of the present disclosure.

FIG. 9 depicts a flow diagram of an illustrative process for an illustrative opportunistic full-duplex downlink transmission system, in accordance with one or more example embodiments of the present disclosure.

FIG. 10 illustrates a functional diagram of an example communication station that may be suitable for use as a user device, in accordance with one or more example embodiments of the present disclosure.

FIG. 11 is a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices, for providing signaling to Wi-Fi devices in various Wi-Fi networks, including, but not limited to, various IEEE 802.11 communication standards (referred to as HE or HEW).

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

During communication between two devices, one or more frames may be sent and received. These frames may include one or more fields (or symbols) that may be based on an IEEE 802.11 standard. In a high efficiency communication (e.g., HEW) these one or more fields may be represented by one or more OFDMA symbols.

Enabling asynchronous OFDMA transmissions during on-going OFDMA downlink and/uplink transmissions may limit performance benefits associated with full-duplex communication. For example, when an access point sends a downlink frame without scheduling uplink transmissions (i.e., half-duplex), the access point does not allocate OFDMA resources to the uplink transmissions and thus may proceed to send downlink frames without sending a full-duplex trigger frame for full-duplex communication.

Example embodiments of the present disclosure relate to systems, methods, and devices to enable asynchronous full-duplex OFDMA transmissions, where an access point pre-allocates OFDMA resources (e.g., sub-channels) to a set (or subset) of wireless communication devices in such a way that their uplink transmission should not interfere with any on-going scheduled OFDMA downlink and/or uplink transmissions. Further example embodiments of the present disclosure relate to systems, methods, and devices to enable asynchronous full-duplex communications where an access point may opportunistically schedule multi-user downlink OFDMA transmissions for latency-sensitive applications in the middle of on-going multi-user uplink OFDMA transmissions such that the downlink transmissions may be completed before the uplink transmissions in the presence of potential interference from the on-going uplink transmissions. As a result of the aforementioned embodiments, latency, which is important for time sensitive applications, is reduced while improving channel utilization through coordinated simultaneous transmissions in an OFDMA system.

The above descriptions are for purposes of illustration and are not meant to be limiting. Numerous other examples, configurations, processes, etc., may exist, some of which are described in detail below. Example embodiments will now be described with reference to the accompanying figures.

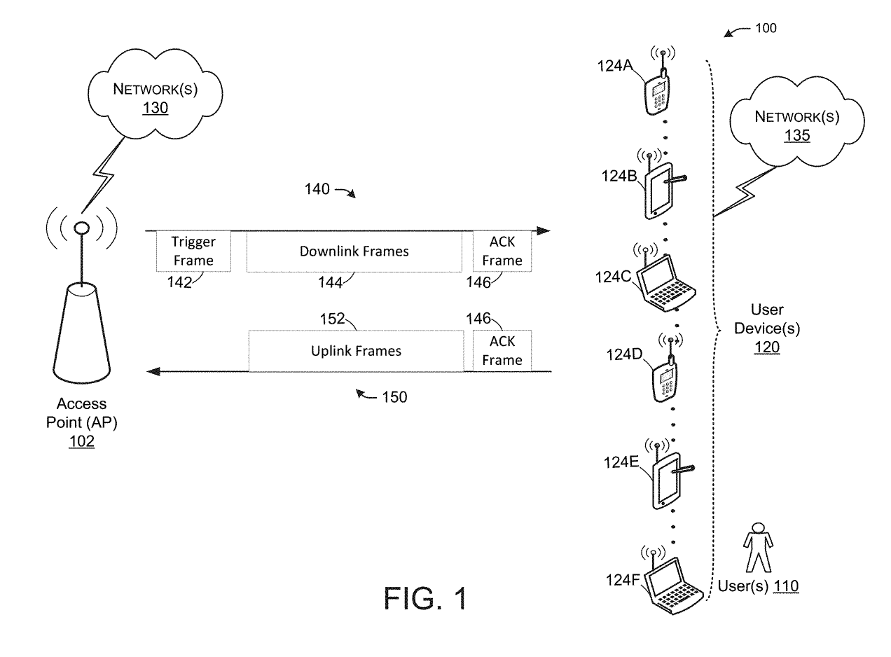

FIG. 1 is a network diagram illustrating an example network environment, according to some example embodiments of the present disclosure. Wireless network 100 may include one or more devices 120 and one or more access point(s) (AP) 102, which may communicate in accordance with IEEE 802.11 communication standards. The device(s) 120 may be mobile devices that are non-stationary and do not have fixed locations.

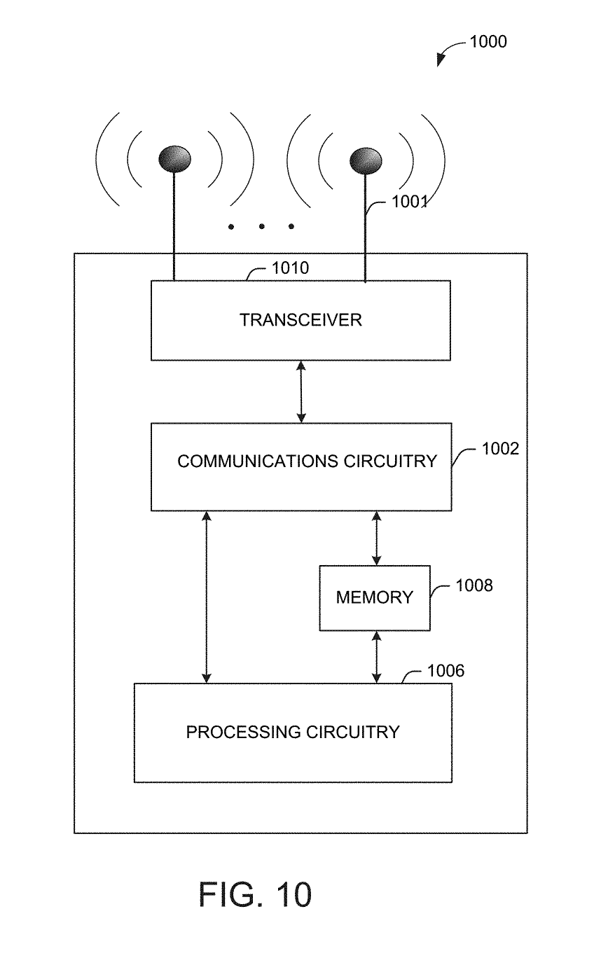

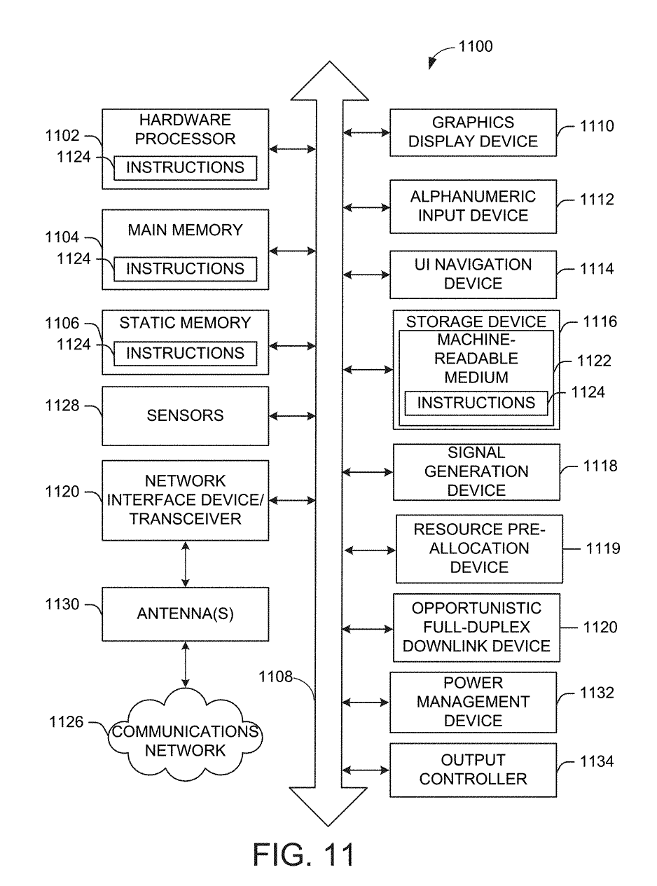

In some embodiments, the user devices 120 and AP 102 may include one or more computer systems similar to that of the functional diagram of FIG. 10 and/or the example machine/system of FIG. 11.

One or more illustrative user device(s) 120 and/or AP 102 may be operable by one or more user(s) 110. The user device(s) 120 (e.g., 124A, 124B, 124C, 124D, 124E, or 124F) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a personal computer (PC), a wearable wireless device (e.g., bracelet, watch, glasses, ring, etc.), a desktop computer, a mobile computer, a laptop computer, an ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. It is understood that the above is a list of devices. However, other devices, including smart devices such as lamps, climate control, car components, household components, appliances, etc. may also be included in this list.

Any of the user device(s) 120 (e.g., user devices 124A-124F), and AP 102 may be configured to communicate with each other via one or more communications networks 130 and/or 135 wirelessly or wired. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124A-124F), and AP 102 may include one or more communications antennas. The one or more communications antennas may be any suitable type of antennas corresponding to the communications protocols used by the user device(s) 120 (e.g., user devices 124A-124F), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124A-124F), and AP 102 may be configured to perform directional transmission and/or directional reception in conjunction with wirelessly communicating in a wireless network. Any of the user device(s) 120 (e.g., user devices 124A-124F), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124A-124F), and AP 102 may be configured to perform any given directional transmission towards one or more defined transmit sectors. Any of the user device(s) 120 (e.g., user devices 124A-124F), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124A-124F), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

Typically, when an AP (e.g., AP 102) establishes communication with one or more user devices 120 (e.g., user devices 124A-124F), the AP may communicate in the downlink direction by sending data frames. The data frames may be preceded by one or more preambles that may be part of one or more headers. These preambles may be used to allow the user device to detect a new incoming data frame from the AP. A preamble may be a signal used in network communications to synchronize transmission timing between two or more devices (e.g., between the APs and user devices). The communication may include communication between legacy devices and/or HEW devices.

In one embodiment, and with reference to FIG. 1, an OFDA downlink transmission 140 from the AP 102 to the user devices 120 may include a full duplex trigger frame 142, one or more downlink data frames 144, and an acknowledgement frame 146. An OFDA uplink transmission 150 from the user devices 120 to the AP 102 may include one or more uplink data frames 152 and an acknowledgement frame 154.

The communication between the AP 102 and the user devices 120 may also include one or more fields (not shown), such as, legacy short training and long training field, a legacy signal field (L-SIG), a high efficiency signal A (HE-SIG-A) field, a high efficiency signal B (HE-SIG-B) field, high efficiency short training and long training fields. These fields may be communicated between the devices such as the AP 102 and one or more user devices 120. The communication may utilize a certain frequency band (e.g., 20, 40, 80, 160 MHz, etc.) based on the device and the IEEE standard followed by the device (e.g., legacy devices or HEW device). For example, legacy devices may utilize a 20 MHz but HEW device may support the same 20 MHz band and larger frequency bands. It is understood that the above acronyms may be different and not to be construed as a limitation as other acronyms maybe used for the fields included in an HEW preamble.

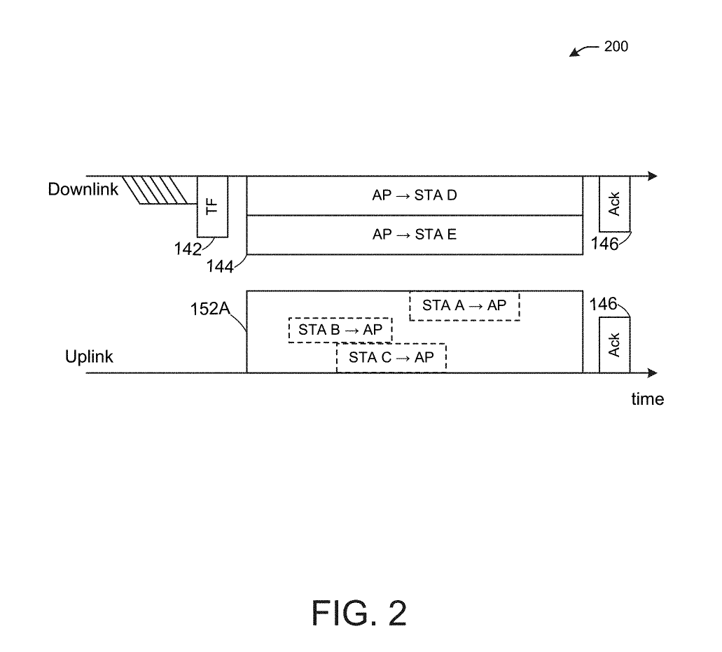

FIG. 2 depicts a diagram illustrating asynchronous pre-allocation-based uplink frame transmissions, according to one or more example embodiments of the disclosure.

In one embodiment, the AP 102 may identify a set (or subset) of OFDMA sub-channels (or resource units (RUs)) that stations A, B, and C may utilize for a potential unsolicited uplink transmission using a set of criteria. The set of criteria may include the potential for causing harmful interference to scheduled OFDMA downlink transmissions 144 from stations D and E, station latency requirements (e.g., time sensitive fames) and a distance to the stations D and E. The stations A, B, C, D, and E as shown in FIG. 2 may correspond to the user devices 124A-124E of FIG. 1. An uplink eligibility evaluation may be performed for a subset of a total number of stations in order to minimize computational overhead/time at the AP 102. For example, the AP 102 may identify only stations with high priority time sensitive traffic for potential uplink transmission.

The AP 102 may pre-allocate one or more OFDMA sub-channels to a specific station or a subset of stations to grant channel access during (i.e., in the middle of) a scheduled OFDMA downlink transmission and/or after the completion of solicited uplink transmissions. For example, the AP 102 may pre-allocate one or more OFDMA sub-channels to stations A, B, and C so that they may complete unsolicited OFDMA uplink transmissions 152A during scheduled OFDMA downlink transmissions 144 for stations D and E. The AP 102 may perform pre-allocation of OFDMA sub-channels by sending the full-duplex trigger frame 142 that may include the following: 1. A resource allocation for scheduled OFDMA downlink transmissions; 2. A resource allocation for solicited OFDMA uplink transmissions; 3. Expected transmission times for scheduled OFDMA downlink and solicited OFDMA uplink transmissions; and 4. Resource pre-allocation (in time and frequency) for potential (unsolicited) OFDMA uplink transmissions. The AP 102 may specify, in the trigger frame 142, additional transmission configurations including, but not limited to, transmit power and modulation and coding scheme (MCS) for the unsolicited OFDMA uplink transmissions 152A in order to facilitate fame acquisition and decoding. The AP 102 may send OFDMA PLCP protocol data unit (PPDU) frames to the scheduled downlink stations D and E and, at the same time, listen for potential uplink transmissions from the unsolicited resource-pre-allocated stations A, B, and C.

The unsolicited OFDMA uplink transmissions 152A may follow 802.11ax triggered OFDMA transmission standards where the relevant tones of high-efficiency short term training fields (HE-STF) and high-efficiency long term training fields (HE-LTF) are populated matching the tones in the OFDMA sub-allocation. The AP 102 may acquire synchronization and channel estimation via HE-STF and HE-LTF. Unsolicited OFDMA uplink transmissions may not include the legacy 20 MHz portion of the uplink (UL) preamble. The AP 102 may send a block acknowledgment to the uplink STAs (e.g., the stations A, B, and C) at the end of the unsolicited OFDMA uplink transmissions 152A to acknowledge the reception of uplink frames.

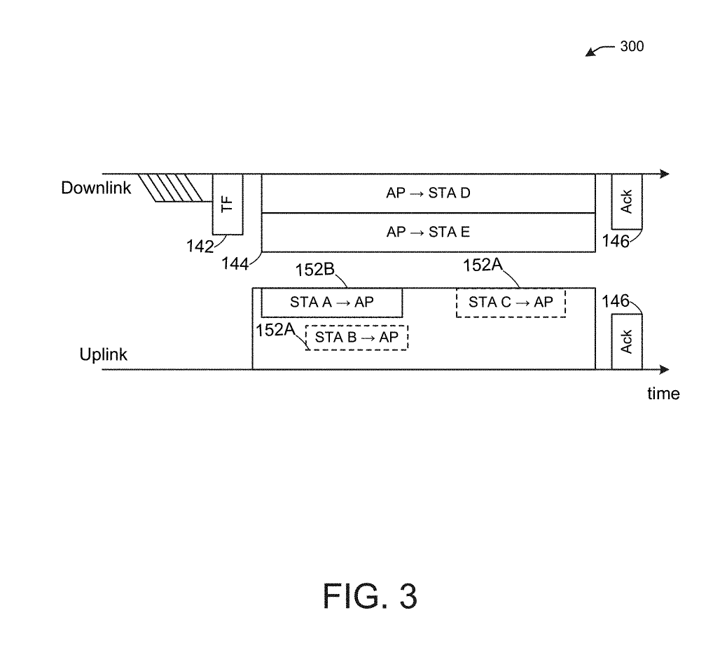

FIG. 3 depicts a diagram illustrating solicited and pre-allocated unsolicited uplink frame transmissions, according to one or more example embodiments of the disclosure.

In one embodiment, the AP 102 may identify a set (or subset) of OFDMA sub-channels (or resource units (RUs)) that stations B and C may utilize for a potential unsolicited uplink transmission using a set of criteria. Station A may be previously scheduled to transmit a solicited uplink transmission 152B to the AP 102. The set of criteria may include the potential for causing harmful interference to scheduled OFDMA downlink transmissions 144 from stations D and E, station latency requirements (e.g., time sensitive fames) and a distance to the stations D and E. The stations A, B, C, D, and E as shown in FIG. 3 may correspond to the user devices 124A-124E of FIG. 1. An uplink eligibility evaluation may be performed for a subset of a total number of stations in order to minimize computational overhead/time at the AP 102. For example, the AP 102 may identify only stations with high priority time sensitive traffic for potential uplink transmission.

The AP 102 may pre-allocate one or more OFDMA sub-channels to a specific station or a subset of stations to grant channel access during (i.e., in the middle of) a scheduled OFDMA downlink transmission and/or after the completion of solicited uplink transmissions. For example, the AP 102 may pre-allocate one or more OFDMA sub-channels to stations B and C so that they may complete unsolicited OFDMA uplink transmissions 152A during scheduled OFDMA downlink transmissions 142 for stations D and E. The AP 102 may perform pre-allocation of OFDMA sub-channels by sending the full-duplex trigger frame 142 that may include the following: 1. A resource allocation for scheduled OFDMA downlink transmissions; 2. A resource allocation for solicited OFDMA uplink transmissions; 3. Expected transmission times for scheduled OFDMA downlink and solicited OFDMA uplink transmissions; and 4. Resource pre-allocation (in time and frequency) for potential (unsolicited) OFDMA uplink transmissions.

The AP 102 may pre-allocate resources such that any unsolicited uplink transmissions (e.g., OFDMA uplink transmissions 152A from the stations B and C) do not overlap with solicited uplink transmissions (e.g., OFDMA uplink transmission 152B) from station A. The AP 102 may process any pre-allocated and unsolicited uplink transmissions for stations B and C utilizing FDMA to enable a gain setting independent of scheduled and/solicited reception with respect to station A.

The AP 102 may specify, in the trigger frame 142, additional transmission configurations including, but not limited to, transmit power and modulation and coding scheme (MCS) for the unsolicited uplink transmissions 152A in order to facilitate fame acquisition and decoding. The AP 102 may send OFDMA PLCP protocol data unit (PPDU) frames to the scheduled downlink stations D and E, receive uplink OFDMA PPDU frames from the solicited uplink station A and, at the same time, listen for potential uplink transmissions from the unsolicited resource-pre-allocated stations B and C. In one embodiment, the AP 102 may pre-allocate OFDMA sub-channels to station C so that it can reuse the resource for a second transmission AGC when station A's solicited transmission is over.

The unsolicited OFDMA uplink transmissions 152A may follow 802.11ax triggered OFDMA transmission standards where the relevant tones of high-efficiency short term training fields (HE-STF) and high-efficiency long term training fields (HE-LTF) are populated matching the tones in the OFDMA sub-allocation. The AP 102 may acquire synchronization and channel estimation via HE-STF and HE-LTF. Unsolicited OFDMA uplink transmissions may not include the legacy 20 MHz portion of the uplink (UL) preamble. The AP 102 may send a block acknowledgment 146 to the uplink STAs (e.g., the stations B and C) at the end of the unsolicited uplink transmissions 152A to acknowledge the reception of the uplink frames.

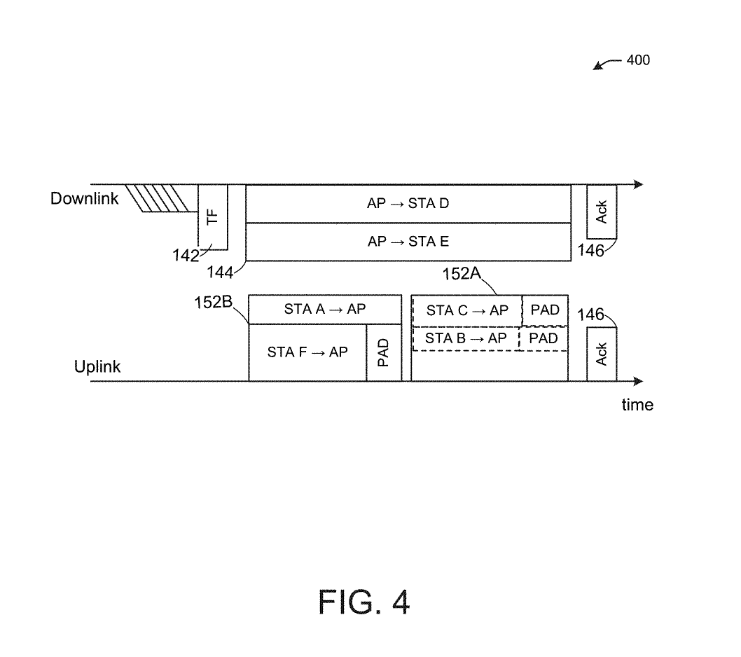

FIG. 4 depicts a diagram illustrating resource pre-allocation in a non-overlapping manner in the presence of solicited uplink frame transmissions, in accordance with one or more example embodiments of the present disclosure.

In one embodiment, the AP 102 may identify a set (or subset) of OFDMA sub-channels (or resource units (RUs)) that stations B and C may utilize for a potential unsolicited uplink transmission using a set of criteria. Stations A and F may be previously scheduled to transmit solicited uplink transmissions 152B to the AP 102. The set of criteria may include the potential for causing harmful interference to scheduled OFDMA downlink transmissions 144 from stations D and E, station latency requirements (e.g., time sensitive fames) and a distance to the stations D and E. The stations A, B, C, D, E, and F as shown in FIG. 4 may correspond to the user devices 124A-124F of FIG. 1. An uplink eligibility evaluation may be performed for a subset of a total number of stations in order to minimize computational overhead/time at the AP 102. For example, the AP 102 may identify only stations with high priority time sensitive traffic for potential uplink transmission.

The AP 102 may pre-allocate one or more OFDMA sub-channels to a specific station or a subset of stations to grant channel access during (i.e., in the middle of) a scheduled OFDMA downlink transmission and/or after the completion of solicited uplink transmissions. For example, the AP 102 may pre-allocate one or more OFDMA sub-channels to stations B and C so that they may complete unsolicited OFDMA uplink transmissions 152A during scheduled OFDMA downlink transmissions 142 for stations D and E. The AP 102 may perform pre-allocation of OFDMA sub-channels by sending the full-duplex trigger frame 142 that may include the following: 1. A resource allocation for scheduled OFDMA downlink transmissions; 2. A resource allocation for solicited OFDMA uplink transmissions; 3. Expected transmission times for scheduled OFDMA downlink and solicited OFDMA uplink transmissions; and 4. Resource pre-allocation (in time and frequency) for potential (unsolicited) OFDMA uplink transmissions.

The AP 102 may pre-allocate resources such that any unsolicited uplink transmissions (e.g., OFDMA uplink transmissions 152A from the stations B and C) do not overlap with solicited uplink transmissions (e.g., OFDMA uplink transmissions 152B) from stations A and F. The AP 102 may process any pre-allocated and unsolicited uplink transmissions for stations B and C utilizing FDMA to enable a gain setting independent of scheduled and/solicited reception with respect to stations A and F. If the AP 102 is not capable of FDMA per-sub-channel processing, it can indicate a window in time for the start of unsolicited uplink transmissions such that the received unsolicited transmissions arrive at the AP 102 within an expected arrival time in order to perform automatic gain control (AGC) settings for combined fast fourier transform (FFT) processing of resource allocations for stations B and C.

The AP 102 may specify, in the trigger frame 142, additional transmission configurations including, but not limited to, transmit power and modulation and coding scheme (MCS) for the unsolicited uplink transmissions 152A in order to facilitate fame acquisition and decoding. The AP 102 may send OFDMA PLCP protocol data unit (PPDU) frames to the scheduled downlink stations D and E, receive uplink OFDMA PPDU frames from the solicited uplink stations A and F, and at the same time, listen for potential uplink transmissions from the unsolicited resource-pre-allocated stations B and C.

The unsolicited OFDMA uplink transmissions 152A may follow 802.11ax triggered OFDMA transmission standards where the relevant tones of high-efficiency short term training fields (HE-STF) and high-efficiency long term training fields (HE-LTF) are populated matching the tones in the OFDMA sub-allocation. The AP 102 may acquire synchronization and channel estimation via HE-STF and HE-LTF. Unsolicited OFDMA uplink transmissions may not include the legacy 20 MHz portion of the uplink (UL) preamble. The AP 102 may send a block acknowledgment 146 to the uplink STAs (e.g., the stations B and C) at the end of the unsolicited uplink transmissions 152A to acknowledge the reception of the uplink frames.

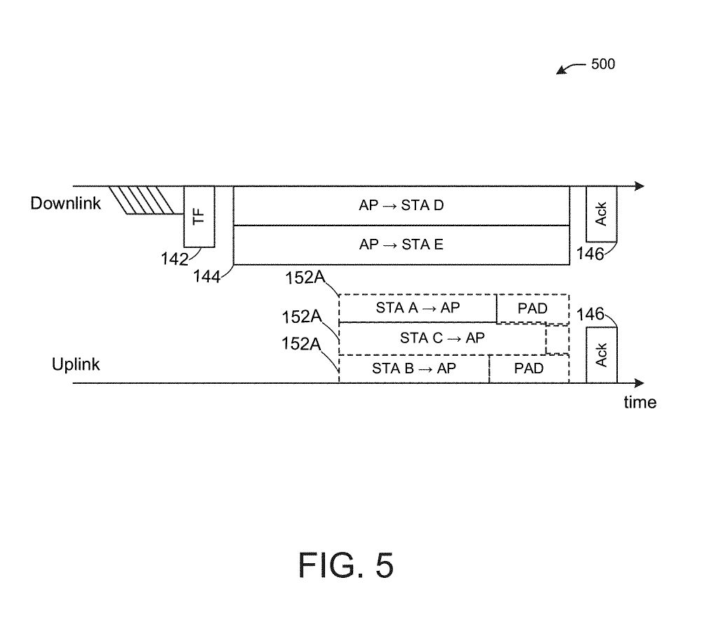

FIG. 5 depicts a diagram illustrating resource pre-allocation in a non-overlapping manner in the absence of solicited uplink frame transmissions, in accordance with one or more example embodiments of the present disclosure.

In one embodiment, the AP 102 may identify a set (or subset) of OFDMA sub-channels (or resource units (RUs)) that stations A, B, and C may utilize for a potential unsolicited uplink transmission using a set of criteria. The set of criteria may include the potential for causing harmful interference to scheduled OFDMA downlink transmissions 144 from stations D and E, station latency requirements (e.g., time sensitive fames) and a distance to the stations D and E. The stations A, B, C, D and E as shown in FIG. 5 may correspond to the user devices 124A-124E of FIG. 1. An uplink eligibility evaluation may be performed for a subset of a total number of stations in order to minimize computational overhead/time at the AP 102. For example, the AP 102 may identify only stations with high priority time sensitive traffic for potential uplink transmission.

The AP 102 may pre-allocate one or more OFDMA sub-channels to a specific station or a subset of stations to grant channel access during (i.e., in the middle of) a scheduled OFDMA downlink transmission and/or after the completion of solicited uplink transmissions. For example, the AP 102 may pre-allocate one or more OFDMA sub-channels to stations A, B, and C so that they may complete unsolicited OFDMA uplink transmissions 152A during scheduled OFDMA downlink transmissions 142 for stations D and E. The AP 102 may perform pre-allocation of OFDMA sub-channels by sending the full-duplex trigger frame 142 that may include the following: 1. A resource allocation for scheduled OFDMA downlink transmissions; 2. A resource allocation for solicited OFDMA uplink transmissions; 3. Expected transmission times for scheduled OFDMA downlink and solicited OFDMA uplink transmissions; and 4. Resource pre-allocation (in time and frequency) for potential (unsolicited) OFDMA uplink transmissions.

The AP 102 may specify, in the trigger frame 142, additional transmission configurations including, but not limited to, transmit power and modulation and coding scheme (MCS) for the unsolicited uplink transmissions 152A in order to facilitate fame acquisition and decoding. The AP 102 may send OFDMA PLCP protocol data unit (PPDU) frames to the scheduled downlink stations D and E and at the same time, listen for potential uplink transmissions from the unsolicited resource-pre-allocated stations A, B, and C.

The unsolicited OFDMA uplink transmissions 152A may follow 802.11ax triggered OFDMA transmission standards where the relevant tones of high-efficiency short term training fields (HE-STF) and high-efficiency long term training fields (HE-LTF) are populated matching the tones in the OFDMA sub-allocation. The AP 102 may acquire synchronization and channel estimation via HE-STF and HE-LTF. Unsolicited OFDMA uplink transmissions may not include the legacy 20 MHz portion of the uplink (UL) preamble. The AP 102 may send a block acknowledgment 146 to the uplink STAs (e.g., the stations A, B and C) at the end of the unsolicited uplink transmissions 152A to acknowledge the reception of the uplink frames.

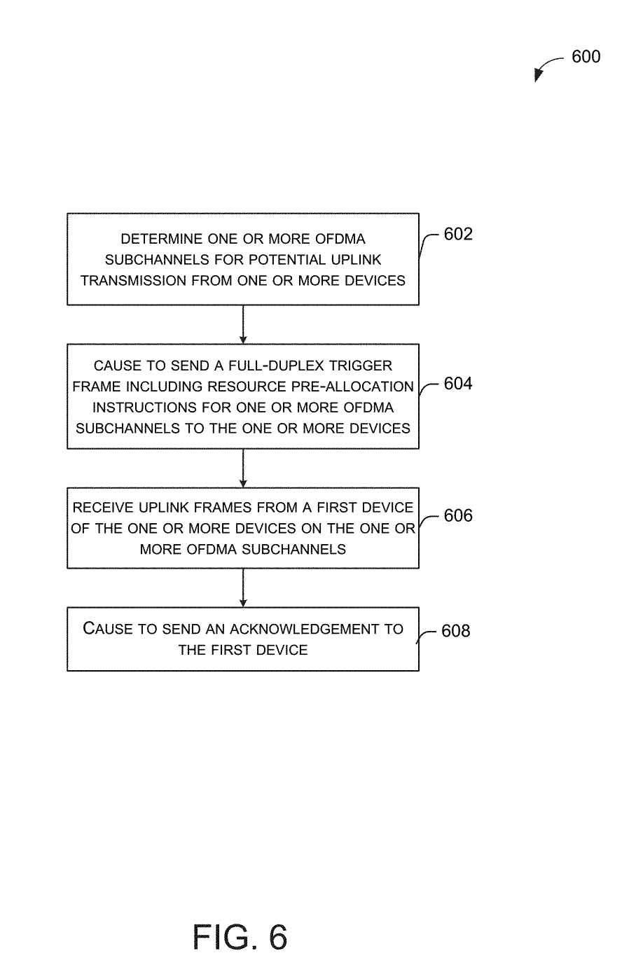

FIG. 6 depicts a flow diagram of an illustrative process 600 for an illustrative OFDMA resource pre-allocation system, in accordance with one or more example embodiments of the present disclosure.

At block 602, a device (e.g., the AP 102 of FIG. 1) may determine (e.g., identify) one or more OFDMA sub-channels for uplink transmissions from one or more devices (e.g., the user devices 120 of FIG. 1).

At block 604, the device may cause to send a full-duplex trigger frame (e.g., the trigger frame 142 of FIG. 1) including resource pre-allocation instructions for one or more OFDMA sub-channels to the one or more devices.

At block 606, the device may receive an uplink transmission (e.g., uplink frames) from a first device of the one or more devices on the one or more OFDMA sub-channels.

At block 608, the device may cause to send an acknowledgement to the first device to confirm reception of the uplink transmission. It is understood that the above descriptions are for purposes of illustration and are not meant to be limiting.

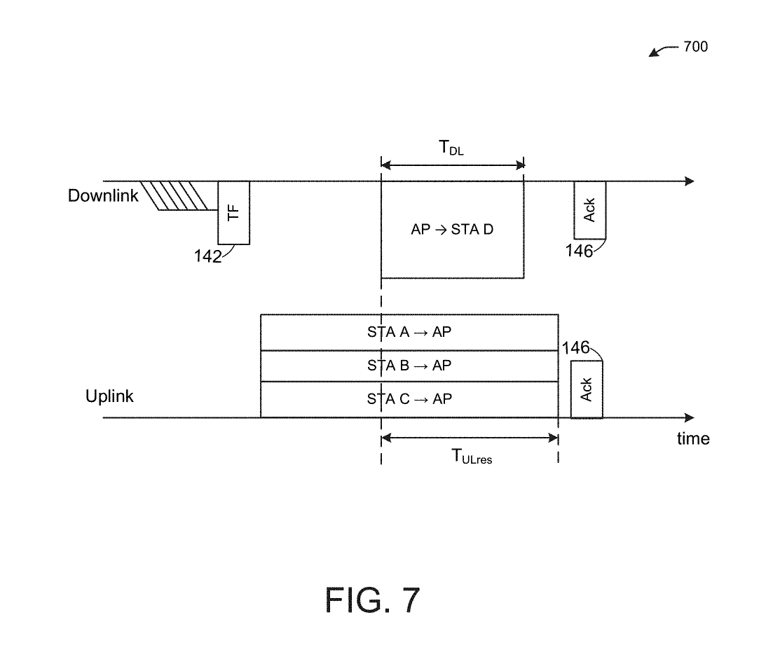

FIG. 7 depicts a diagram illustrating opportunistic full-duplex downlink transmission based on a first residual uplink transmission time, in accordance with one or more example embodiments of the present disclosure.

In one embodiment, the AP 102 may perform multi-user (MU) uplink (UL) OFDMA scheduling for potential latency-sensitive download transmissions. When the AP 102 schedules MU UL OFDMA transmissions, it may select uplink stations and schedule their uplink transmissions so that they do not cause significant interference to target downlink stations for potential downlink transmissions for latency-sensitive data. It should be understood that the AP 102 may have inter-station interference information (or alternatively, an interference map) for the target downlink stations (e.g., the interference between the target downlink station D and the uplink stations A, B, and C). It should further be understood that the AP 102 may or may not consider opportunistic downlink transmission in uplink scheduling based on latency requirements. For example, the AP 102 may not consider opportunistic downlink transmission in scheduling MU UL OFDMA transmissions if the scheduled UL OFDMA transmission time is short and thus does not violate downlink latency requirements (e.g., the AP 102 can schedule downlink transmissions after the completion of UL OFDMA transmissions while still meeting latency requirements).

When the AP 102 schedules MU UL OFDMA transmissions, it may send an uplink trigger frame (e.g., the trigger frame 142) soliciting UL OFDMA transmissions. The trigger frame 142 may include information indicating that certain downlink stations (which are serving latency-sensitive applications) should not, for example, enter a low-power sleep state in order to receive potential downlink transmissions from the AP 102 in the middle of solicited MU UL OFDMA transmissions.

Turning now to FIG. 7, upon receiving data (e.g., from the Internet) for latency-sensitive downlink transmission in the middle of solicited MU UL OFDMA transmissions, the AP 102 may estimate downlink transmission configurations (e.g., transmit power, MCS, etc.) for station D based on expected inter-station interference from on-going MU UL transmissions with respect to stations A, B, and C. The stations A, B, C and D as shown in FIG. 7 may correspond to the user devices 124A-124D of FIG. 1. Based on the downlink transmission configurations, the AP 102 may estimate an expected downlink transmission time E[T_{DL}] with respect to station D. If the estimated downlink transmission time exceeds a residual time of scheduled MU UL OFDMA transmissions with respect to stations A, B, and C (i.e., E[T_{DL}]>E[T_{UL, res}]), the AP 102 may wait until the end of any on-going uplink transmissions before scheduling the downlink transmission for station D. If however, the estimated transmission time is less than the residual MU UL OFDMA transmission time (i.e., E[T_{DL}]<E[T_{UL, res}]), the AP 102 may immediately transmit downlink frames to station D using the entire channel bandwidth (i.e., OFDM) with the estimated downlink transmission configurations. The AP 102 may receive acknowledgment frames 146 after the completion of any downlink or uplink transmissions, whichever comes later.

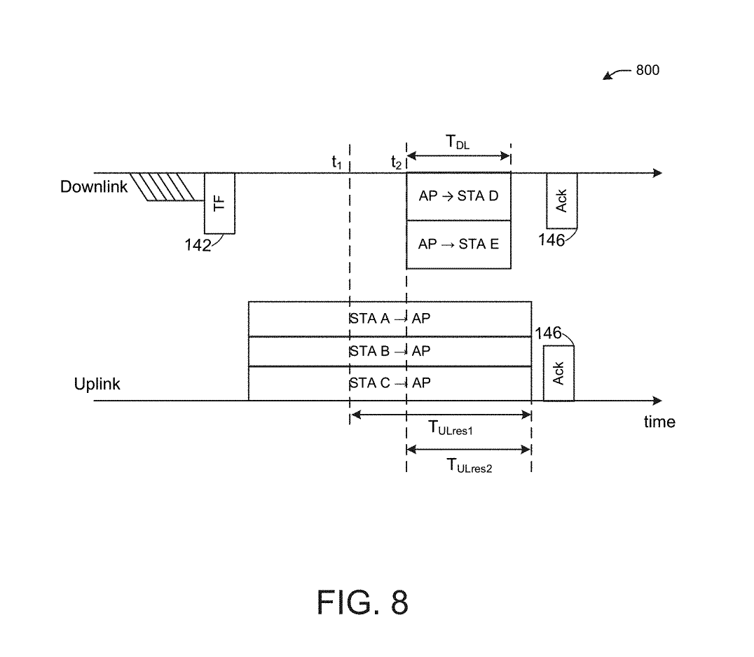

FIG. 8 depicts a diagram illustrating opportunistic full-duplex downlink transmission based on a second residual uplink transmission time, in accordance with one or more example embodiments of the present disclosure.

The AP 102, upon receiving data (e.g., from the Internet) for latency-sensitive downlink transmission in the middle of solicited MU UL OFDMA transmissions, may estimate downlink transmission configurations (e.g., transmit power, MCS, etc.) for station D based on expected inter-station interference from on-going MU UL transmissions with respect to stations A, B, and C. The stations A, B, C, D, and E as shown in FIG. 8 may correspond to the user devices 124A-124E of FIG. 1. Based on the downlink transmission configurations, the AP 102 may estimate an expected downlink transmission time E[T_{DL}] with respect to station D. If the estimated downlink transmission time exceeds a residual time of scheduled MU UL OFDMA transmissions with respect to stations A, B, and C (i.e., E[T_{DL}]>E[T_{UL, res}]), the AP 102 may wait until the end of any on-going uplink transmissions before scheduling the downlink transmission for station D. If however, the estimated transmission time is much less than a residual MU UL OFDMA transmission time (i.e., E[T_{DL}] (at t₁)<E[T_{UL, res, 1}]), the AP 102 may wait until it receives additional data for downlink transmissions with respect to station D. The AP 102 may then receive downlink data for station E at a second time interval (t₂) and estimate that E[T_{DL}] (at t₂)<E[T_{UL, res, 2}]). The AP 102 may then schedule MU DL OFDMA transmissions for both stations D and E. For example, the AP 102, upon receiving the downlink data for station E (e.g., latency-sensitive downlink transmission data), may estimate downlink transmission configurations (e.g., transmit power, MCS, etc.) and an expected downlink transmission time for station E. The AP 102 may then transmit the downlink transmissions for both stations D and E. It should be understood that the AP 102 is not limited to scheduling two downlink transmissions and thus the embodiments described herein may be extended to scheduling more than two downlink transmissions from more than two stations.

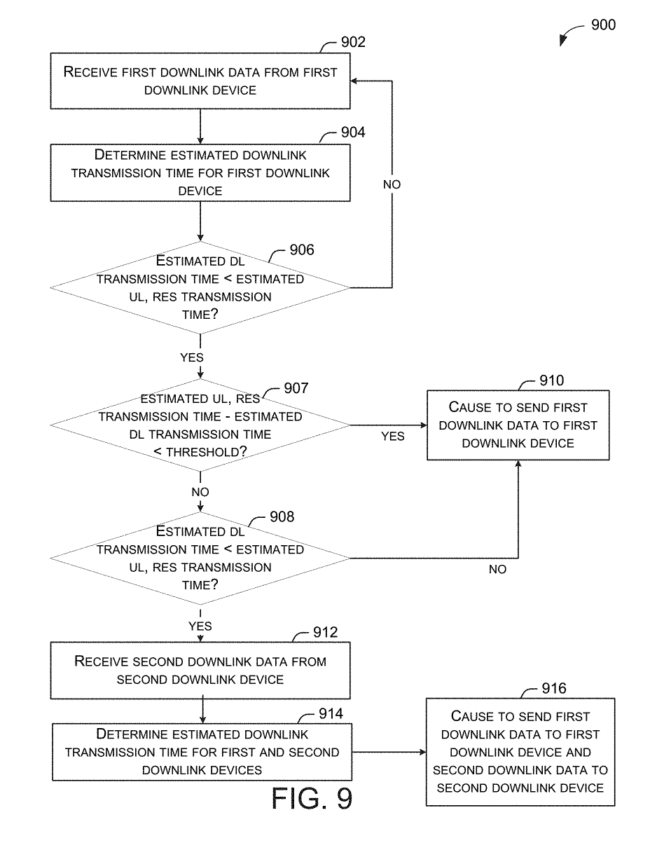

FIG. 9 depicts a flow diagram of an illustrative process 900 for an illustrative opportunistic full-duplex downlink transmission system, in accordance with one or more example embodiments of the present disclosure.

At block 902, a device (e.g., the AP 102 of FIG. 1) may receive first downlink data from the network 130 for a first downlink device (e.g., one of the user devices 120 of FIG. 1). For example, a user device may establish a wireless communication channel with an AP. The wireless communication channel may be configured to be operational on various frequency bands.

At block 904, the AP may determine an estimated downlink transmission time for the first downlink device. For example, the AP may determine an estimated time for sending data to a user device in communication with the AP.

At block 906, the AP may determine whether the estimated downlink transmission time for the first downlink device is less than a first estimated residual uplink transmission time for an uplink device. For example, the AP may determine if the estimated downlink transmission time for a user device scheduled to send downlink data is less than an estimated residual uplink transmission time for a user device (or user devices, e.g., stations A-C shown in FIG. 7) currently sending uplink data to the AP.

If, at block 906, the AP determines that the estimated downlink transmission time for the first downlink device is greater than the first estimated residual uplink transmission time for the uplink device, then the process 900 returns to block 902 where the AP waits to receive additional downlink data from the network 130. If, at block 906, the AP determines that the estimated downlink transmission time for the first downlink device is less than the estimated residual uplink transmission time for the uplink device(s), then the process 900 continues to block 907.

At block 907, the AP may determine if a difference between the residual uplink transmission time and the estimated downlink transmission time for the first downlink device is less than a pre-defined threshold. If the difference is below the threshold, then the process 900 continues to block 910 where the AP may cause to send the first downlink data to the first downlink device.

If, at block 907, the AP determines that the difference between the residual uplink transmission time and the estimated downlink transmission time for the first downlink device is greater than the pre-defined threshold, then the process 900 continues to block 908. In one embodiment, the AP may also wait for additional downlink data from the network 130 to schedule one or more additional downlink data transmissions to one or more downlink devices using OFDMA. It should be understood that even if the AP waits for additional downlink data, the AP may send the first downlink data in a single user OFDM transmission when the residual uplink transmission time is equal to the estimated downlink transmission time for the first downlink device because otherwise, the AP may not be able to transmit the first downlink data.

At block 908, the AP may determine whether the estimated downlink transmission time for the first downlink device is less than a second estimated residual uplink transmission time for a second uplink device. For example, the AP may determine if the estimated downlink transmission time for a user device scheduled to send downlink data is less than an estimated residual uplink transmission time for first and second user devices currently sending uplink data to the AP. If at block 908, the AP determines that the estimated downlink transmission time for the first device is greater than a second estimated residual uplink transmission time for a second uplink device, then the process 900 continues at block 910 where the AP may cause to send the first downlink data in a transmission to the first device during the residual time interval in which the first uplink device is sending uplink data to the AP. If, at block 908, the AP determines that the estimated downlink transmission time for the first downlink device is less than a second estimated residual uplink transmission time for the second uplink device, then the process 900 continues to block 912. It should be understood that, in one embodiment, if the AP waits for additional downlink data (e.g., from the Internet), then upon receipt of the additional downlink data, the AP may allocate OFDMA resources to schedule both the first and second downlink data transmissions. Then, the AP may estimate the downlink OFDMA transmission time and compare with the estimated residual uplink transmission time. If the AP can still finish downlink OFDMA transmission before an on-going uplink transmission ends, the AP may start the OFDMA downlink transmission for both downlink devices. If the AP cannot finish the OFDMA downlink transmission, then it may send a single user OFDM downlink transmission to the first downlink device.

At block 912, the AP receives second downlink data from a second downlink device. For example, a second user device may establish a wireless communication channel with an AP. The wireless communication channel may be configured to be operational on various frequency bands.

At block 914, the AP may determine an estimated downlink transmission time for the second downlink device. For example, the AP may determine an estimated time for sending data to a second user device in communication with the AP.

At block 916, the AP may cause to send the first downlink data in a transmission to the first downlink device and the second downlink data in a transmission to the second downlink device, during the residual time interval in which the first and second uplink devices are sending uplink data to the AP. It is understood that the above descriptions are for purposes of illustration and are not meant to be limiting. For example, while the description of the aforementioned embodiments provide examples for two downlink devices, in other embodiments, the AP downlink scheduling decision process may be extended to multiple (i.e., more than two) downlink data transmissions for multiple downlink devices.

FIG. 10 shows a functional diagram of an exemplary communication station 1000 in accordance with some embodiments. In one embodiment, FIG. 10 illustrates a functional block diagram of a communication station that may be suitable for use as an AP 102 (FIG. 1) or a user device 120 (FIG. 1) in accordance with some embodiments. The communication station 1000 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1000 may include communications circuitry 1002 and a transceiver 1010 for transmitting and receiving signals to and from other communication stations using one or more antennas 1001. The communications circuitry 1002 may include circuitry that can operate the physical layer (PHY) communications and/or media access control (MAC) communications for controlling access to the wireless medium, and/or any other communications layers for transmitting and receiving signals. The communication station 1000 may also include processing circuitry 1006 and memory 1008 arranged to perform the operations described herein. In some embodiments, the communications circuitry 1002 and the processing circuitry 1006 may be configured to perform operations detailed in FIGS. 1-9.

In accordance with some embodiments, the communications circuitry 1002 may be arranged to contend for a wireless medium and configure frames or packets for communicating over the wireless medium. The communications circuitry 1002 may be arranged to transmit and receive signals. The communications circuitry 1002 may also include circuitry for modulation/demodulation, upconversion/downconversion, filtering, amplification, etc. In some embodiments, the processing circuitry 1006 of the communication station 1000 may include one or more processors. In other embodiments, two or more antennas 1001 may be coupled to the communications circuitry 1002 arranged for sending and receiving signals. The memory 1008 may store information for configuring the processing circuitry 1006 to perform operations for configuring and transmitting message frames and performing the various operations described herein. The memory 1008 may include any type of memory, including non-transitory memory, for storing information in a form readable by a machine (e.g., a computer). For example, the memory 1008 may include a computer-readable storage device, read-only memory (ROM), random-access memory (RAM), magnetic disk storage media, optical storage media, flash-memory devices and other storage devices and media.

In some embodiments, the communication station 1000 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1000 may include one or more antennas 1001. The antennas 1001 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1000 may include one or more of a keyboard, a display, a non-volatile memory port, multiple antennas, a graphics processor, an application processor, speakers, and other mobile device elements. The display may be an LCD screen including a touch screen.

Although the communication station 1000 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1000 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1000 may include one or more processors and may be configured with instructions stored on a computer-readable storage device memory.

FIG. 11 illustrates a block diagram of an example of a machine 1100 or system upon which any one or more of the techniques (e.g., methodologies) discussed herein may be performed. In other embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environments. The machine 1100 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1100 may include a hardware processor 1102 (e.g., a central processing unit (CPU), a graphics processing unit (GPU), a hardware processor core, or any combination thereof), a main memory 1104 and a static memory 1106, some or all of which may communicate with each other via an interlink (e.g., bus) 1108. The machine 1100 may further include a power management device 1132, a graphics display device 1110, an alphanumeric input device 1112 (e.g., a keyboard), and a user interface (UI) navigation device 1114 (e.g., a mouse). In an example, the graphics display device 1110, alphanumeric input device 1112, and UI navigation device 1114 may be a touch screen display. The machine 1100 may additionally include a storage device (i.e., drive unit) 1116, a signal generation device 1118 (e.g., a speaker), a resource pre-allocation device 1119, a network interface device/transceiver 1120 coupled to antenna(s) 1130, and one or more sensors 1128, such as a global positioning system (GPS) sensor, a compass, an accelerometer, or other sensor, and an opportunistic full-duplex downlink device 1125. The machine 1100 may include an output controller 1134, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 1116 may include a machine readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within the static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

The resource pre-allocation device 1119 may carry out or perform any of the operations and processes (e.g., process 600) described and shown above. For example, the resource pre-allocation device 1119 may be configured to identify one or more OFDMA sub-channels for potential uplink transmission from one or more devices. The resource pre-allocation device 1119 may further be configured to cause to send a full-duplex trigger frame including resource pre-allocation instructions for the one or more OFDMA sub-channels, to the one or more devices. The resource pre-allocation device 1119 may further be configured to receive uplink frames from the one or more devices on the one or more OFDMA sub-channels. The resource pre-allocation device 1119 may further be configured to cause to send an acknowledgement to the one or more devices. It is understood that the above descriptions are for purposes of illustration and are not meant to be limiting.

The opportunistic full-duplex downlink device 1125 may carry out or perform any of the operations and processes (e.g., process 900) described and shown above. The opportunistic full-duplex downlink device 1125 may be configured to receive first downlink data from a first device. The opportunistic full-duplex downlink device 1125 may further be configured to determine an estimated downlink transmission time for the first device. The opportunistic full-duplex downlink device 1125 may further be configured to determine if an estimated downlink transmission time is less than a first estimated residual uplink transmission time. The opportunistic full-duplex downlink device 1125 may further be configured to determine if the estimated downlink transmission time is less than a second estimated residual uplink transmission time. The opportunistic full-duplex downlink device 1125 may further be configured to receive additional first downlink data from the first device upon determining that the estimated downlink transmission time is less than the second estimated residual uplink transmission time. The opportunistic full-duplex downlink device 1125 may further be configured to cause to send the first downlink transmission to the first device upon determining that the estimated downlink transmission time is not less than the second estimated residual uplink transmission time. The opportunistic full-duplex downlink device 1125 may further be configured to receive second downlink data from a second device upon determining that the estimated downlink transmission time is less than the second estimated residual uplink transmission time. The opportunistic full-duplex downlink device 1125 may further be configured to determine an estimated downlink transmission time for the second device. The opportunistic full-duplex downlink device 1125 may further be configured to cause to send the first downlink transmission to the first device and the second downlink transmission to the second device. It is understood that the above descriptions are for purposes of illustration and are not meant to be limiting.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1100 and that cause the machine 1100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1124 may further be transmitted or received over a communications network 1126 using a transmission medium via the network interface device/transceiver 1120 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1120 may include one or more physical jacks (e.g., Ethernet, coaxial, or phone jacks) or one or more antennas to connect to the communications network 1126. In an example, the network interface device/transceiver 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1100 and includes digital or analog communications signals or other intangible media to facilitate communication of such software. The operations and processes (e.g., processes 600 and 900) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include a memory and processing circuitry configured to: determine one or more Orthogonal Frequency-Division Multiple Access (OFDMA) sub-channels for uplink transmissions from one or more other devices; cause to send a full-duplex trigger frame including resource pre-allocation instructions for the one or more OFDMA sub-channels to the one or more other devices; receive at least a first uplink transmission from a first device of the one or more other devices on the one or more OFDMA sub-channels; and cause to send an acknowledgement of the received at least the first uplink transmission to the first device.

The implementations may include one or more of the following features. The one or more OFDMA sub-channels for uplink transmissions from the one or more other devices may be determined based at least in part on a latency requirement. The one or more OFDMA sub-channels for uplink transmissions from the one or more other devices may be determined based at least in part on a respective distances to the one or more other devices. The full-duplex trigger frame may include one or more of: a resource allocation for at least one scheduled downlink transmission, a resource allocation for at least one solicited uplink transmission, an expected transmission time for the at least one scheduled downlink transmission, or an expected transmission time for at least one solicited uplink transmission. The resource pre-allocation instructions may include instructions to schedule the at least the first uplink transmission without overlapping with a scheduled solicited uplink transmission. The at least the first uplink transmission may be an unsolicited uplink transmission. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include determining one or more Orthogonal Frequency-Division Multiple Access (OFDMA) sub-channels for a potential uplink transmissions from one or more other devices; causing to send a full-duplex trigger frame including resource pre-allocation instructions for the one or more OFDMA sub-channels, to the one or more other devices; receiving at least a first uplink transmission from a first device of the one or more other devices on the one or more OFDMA sub-channels; and causing to send an acknowledgement of the received at least the first uplink transmission to the first device.

The implementations may include one or more of the following features. The one or more OFDMA sub-channels for uplink transmissions from the one or more other devices may be determined based at least in part on a latency requirement. The one or more OFDMA sub-channels for uplink transmissions from the one or more other devices may be determined based at least in part on a respective distances to the one or more other devices. The full-duplex trigger frame may include one or more of: a resource allocation for at least one scheduled downlink transmission, a resource allocation for at least one solicited uplink transmission, an expected transmission time for the at least one scheduled downlink transmission, or an expected transmission time for at least one solicited uplink transmission. The resource pre-allocation instructions may include instructions to schedule the at least the first uplink transmission without overlapping with a scheduled solicited uplink transmission. The at least the first uplink transmission may be an unsolicited uplink transmission.

According to example embodiments of the disclosure, there may include a method. The method may include determining one or more Orthogonal Frequency-Division Multiple Access (OFDMA) sub-channels for a potential uplink transmissions from one or more other devices; causing to send a full-duplex trigger frame including resource pre-allocation instructions for the one or more OFDMA sub-channels, to the one or more other devices; receiving at least a first uplink transmission from a first device of the one or more other devices on the one or more OFDMA sub-channels; and causing to send an acknowledgement of the received at least the first uplink transmission to the first device.

The implementations may include one or more of the following features. The one or more OFDMA sub-channels for uplink transmissions from the one or more other devices may be determined based at least in part on a latency requirement. The one or more OFDMA sub-channels for uplink transmissions from the one or more other devices may be determined based at least in part on a respective distances to the one or more other devices. The full-duplex trigger frame may include one or more of: a resource allocation for at least one scheduled downlink transmission, a resource allocation for at least one solicited uplink transmission, an expected transmission time for the at least one scheduled downlink transmission, or an expected transmission time for at least one solicited uplink transmission. The resource pre-allocation instructions may include instructions to schedule the at least the first uplink transmission without overlapping with a scheduled solicited uplink transmission. The at least the first uplink transmission may be an unsolicited uplink transmission.

In example embodiments of the disclosure, there may be an apparatus. The apparatus may include means for determining one or more Orthogonal Frequency-Division Multiple Access (OFDMA) sub-channels for a potential uplink transmissions from one or more other devices; means for causing to send a full-duplex trigger frame including resource pre-allocation instructions for the one or more OFDMA sub-channels, to the one or more other devices; means for receiving at least a first uplink transmission from a first device of the one or more other devices on the one or more OFDMA sub-channels; and means for causing to send an acknowledgement of the received at least the first uplink transmission to the first device.

The implementations may include one or more of the following features. The one or more OFDMA sub-channels for uplink transmissions from the one or more other devices may be determined based at least in part on a latency requirement. The one or more OFDMA sub-channels for uplink transmissions from the one or more other devices may be determined based at least in part on a respective distances to the one or more other devices. The full-duplex trigger frame may include one or more of: a resource allocation for at least one scheduled downlink transmission, a resource allocation for at least one solicited uplink transmission, an expected transmission time for the at least one scheduled downlink transmission, or an expected transmission time for at least one solicited uplink transmission. The resource pre-allocation instructions may include instructions to schedule the at least the first uplink transmission without overlapping with a scheduled solicited uplink transmission. The at least the first uplink transmission may be an unsolicited uplink transmission.

According to example embodiments of the disclosure, there may be a device. The device may include a memory and processing circuitry configured to: receive first downlink data from a first downlink device; determine an estimated downlink transmission time for the first downlink device; determine an estimated residual uplink transmission time; and cause to send a first downlink transmission to the first downlink device based at least in part on the estimated residual uplink transmission time.

The implementations may include one or more of the following features. The at least one processor may be configured to execute further computer-executable instructions to cause to send a first downlink transmission to the first downlink device and a second downlink transmission to a second downlink device, based at least in part on the estimated residual uplink transmission time. The estimated downlink transmission time for the first downlink device may be determined based on a transmission configuration for the first downlink device. The transmission configuration for the first downlink device may be at least one of a transmit power and a modulation and coding scheme (MCS). The at least one processor may cause to send the first downlink transmission to the first downlink device when the estimated downlink transmission time is less than the first estimated residual uplink transmission time. The at least one processor may cause to send the first downlink transmission to the first downlink device and the second downlink transmission to the second downlink device when the estimated downlink transmission time is less than the estimated residual uplink transmission time. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include receiving first downlink data from a first downlink device; determining an estimated downlink transmission time for the first downlink device; determining an estimated residual uplink transmission time; and causing to send a first downlink transmission to the first downlink device based at least in part on the estimated residual uplink transmission time.

The implementations may include one or more of the following features. The non-transitory computer-readable medium may cause the processor to perform further operations including causing to send a first downlink transmission to the first downlink device and a second downlink transmission to a second downlink device, based at least in part on the estimated residual uplink transmission time. The estimated downlink transmission time for the first downlink device may be determined based on a transmission configuration for the first downlink device. The transmission configuration for the first downlink device comprises at least one of a transmit power and a modulation and coding scheme (MCS). The non-transitory computer-readable medium may cause the processor to perform further operations including causing to send the first downlink transmission to the first downlink device when the estimated downlink transmission time is less than the estimated residual uplink transmission time. The non-transitory computer-readable medium may cause the processor to perform further operations including causing to send the first downlink transmission to the first downlink device and the second downlink transmission to the second downlink device when the estimated downlink transmission time is less than the estimated residual uplink transmission time.

According to example embodiments of the disclosure, there may include a method. The method may include receiving first downlink data from a first downlink device; determining an estimated downlink transmission time for the first downlink device; determining an estimated residual uplink transmission time; and causing to send a first downlink transmission to the first downlink device based at least in part on the estimated residual uplink transmission time.

The implementations may include one or more of the following features. The method may further include causing to send a first downlink transmission to the first downlink device and a second downlink transmission to a second downlink device, based at least in part on the estimated residual uplink transmission time. The estimated downlink transmission time for the first downlink device may be determined based on a transmission configuration for the first downlink device. The transmission configuration for the first downlink device comprises at least one of a transmit power and a modulation and coding scheme (MCS). The method may further include causing to send the first downlink transmission to the first downlink device when the estimated downlink transmission time is less than the estimated residual uplink transmission time. The method may further include causing to send the first downlink transmission to the first downlink device and the second downlink transmission to the second downlink device when the estimated downlink transmission time is less than the estimated residual uplink transmission time.

In example embodiments of the disclosure, there may be an apparatus. The apparatus may include means for receiving first downlink data from a first downlink device; determining an estimated downlink transmission time for the first downlink device; determining an estimated residual uplink transmission time; and causing to send a first downlink transmission to the first downlink device based at least in part on the estimated residual uplink transmission time.

The implementations may include one or more of the following features. The apparatus may further include means for causing to send a first downlink transmission to the first downlink device and a second downlink transmission to a second downlink device, based at least in part on the estimated residual uplink transmission time. The estimated downlink transmission time for the first downlink device may be determined based on a transmission configuration for the first downlink device. The transmission configuration for the first downlink device comprises at least one of a transmit power and a modulation and coding scheme (MCS). The apparatus may further include means for causing to send the first downlink transmission to the first downlink device when the estimated downlink transmission time is less than the estimated residual uplink transmission time. The apparatus may further include means for causing to send the first downlink transmission to the first downlink device and the second downlink transmission to the second downlink device when the estimated downlink transmission time is less than the estimated residual uplink transmission time.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising a memory and processing circuitry configured to:
determine one or more Orthogonal Frequency-Division Multiple Access (OFDMA) sub-channels for uplink transmissions from one or more other devices;
cause to send a full-duplex trigger frame including resource pre-allocation instructions for the one or more OFDMA sub-channels to the one or more other devices;
receive at least a first uplink transmission from a first device of the one or more other devices on the one or more OFDMA sub-channels; and
cause to send an acknowledgement of the received at least the first uplink transmission to the first device.

2. The device of claim 1, wherein the one or more OFDMA sub-channels for uplink transmissions from the one or more other devices are determined based at least in part on a latency requirement.

3. The device of claim 1, wherein the one or more OFDMA sub-channels for uplink transmissions from the one or more other devices are determined based at least in part on a respective distances to the one or more other devices.

4. The device of claim 1, wherein the full-duplex trigger frame further includes one or more of: a resource allocation for at least one scheduled downlink transmission, a resource allocation for at least one solicited uplink transmission, an expected transmission time for the at least one scheduled downlink transmission, or an expected transmission time for at least one solicited uplink transmission.

5. The device of claim 1, wherein the resource pre-allocation instructions comprise instructions to schedule the at least the first uplink transmission without overlapping with a scheduled solicited uplink transmission.

6. The device of claim 1, wherein the at least the first uplink transmission is an unsolicited uplink transmission.

7. The device of claim 1, further comprising a transceiver configured to transmit and receive wireless signals.

8. The device of claim 7, further comprising one or more antennas coupled to the transceiver.

9. A non-transitory computer-readable medium storing computer-executable instructions which when executed by one or more processors result in performing operations comprising:
determining one or more Orthogonal Frequency-Division Multiple Access (OFDMA) sub-channels for a potential uplink transmissions from one or more other devices;
causing to send a full-duplex trigger frame including resource pre-allocation instructions for the one or more OFDMA sub-channels, to the one or more other devices;
receiving at least a first uplink transmission from a first device of the one or more other devices on the one or more OFDMA sub-channels; and
causing to send an acknowledgement of the received at least the first uplink transmission to the first device.

10. The non-transitory computer-readable medium of claim 9, wherein the one or more OFDMA sub-channels for uplink transmissions from the one or more other devices are determined based at least in part on a latency requirement.

11. The non-transitory computer-readable medium of claim 9, wherein the one or more OFDMA sub-channels for uplink transmissions from the one or more other devices are determined based at least in part on a respective distances to the one or more other devices.

12. The non-transitory computer-readable medium of claim 9, wherein the full-duplex trigger frame further includes one or more of: a resource allocation for at least one scheduled downlink transmission, a resource allocation for at least one solicited uplink transmission, an expected transmission time for the at least one scheduled downlink transmission, and an expected transmission time for at least one solicited uplink transmission.

13. The non-transitory computer-readable medium of claim 9, wherein the resource pre-allocation instructions comprise instructions to schedule the at least the first uplink transmission without overlapping with a scheduled solicited uplink transmission.

14. The non-transitory computer-readable medium of claim 9, wherein the at least the first uplink transmission is an unsolicited uplink transmission.

15. A method comprising:
determining one or more Orthogonal Frequency-Division Multiple Access (OFDMA) sub-channels for uplink transmissions from one or more other devices;
causing to send a full-duplex trigger frame including resource pre-allocation instructions for the one or more OFDMA sub-channels, to the one or more other devices;
receiving at least a first uplink transmission from a first device of the one or more other devices on the one or more OFDMA sub-channels; and
causing to send an acknowledgement of the received at least the first uplink transmission to the first device.

16. The method of claim 15, wherein the one or more OFDMA sub-channels for uplink transmissions from the one or more other devices are determined based at least in part on a latency requirement.

17. The method of claim 15, wherein the one or more OFDMA sub-channels for uplink transmissions from the one or more other devices are determined based at least in part on a respective distances to the one or more other devices.

18. The method of claim 15, wherein the full-duplex trigger frame further includes one or more of: a resource allocation for at least one scheduled downlink transmission, a resource allocation for at least one solicited uplink transmission, an expected transmission time for the at least one scheduled downlink transmission, and an expected transmission time for at least one solicited uplink transmission.

19. The method of claim 15, wherein the resource pre-allocation instructions comprise instructions to schedule the at least the first uplink transmission without overlapping with a scheduled solicited uplink transmission.

20. The method of claim 15, wherein the at least the first uplink transmission is an unsolicited uplink transmission.

21. A device, the device comprising a memory and processing circuitry configured to:
receive first downlink data from a first downlink device;
determine an estimated downlink transmission time for the first downlink device;
determine an estimated residual uplink transmission time; and
cause to send a first downlink transmission to the first downlink device based at least in part on the estimated residual uplink transmission time.

22. The device of claim 21, wherein the at least one processor is configured to execute further computer-executable instructions to cause to send a first downlink transmission to the first downlink device and a second downlink transmission to a second downlink device, based at least in part on the estimated residual uplink transmission time.

23. The device of claim 21, wherein the estimated downlink transmission time for the first downlink device is determined based on a transmission configuration for the first downlink device.

24. The device of claim 23, wherein the transmission configuration for the first downlink device comprises at least one of a transmit power and a modulation and coding scheme (MCS).

25. The device of claim 21, wherein the computer-executable instructions executed by the at least one processor to cause to send the first downlink transmission to the first downlink device, comprise computer-executable instructions to cause to send the first downlink transmission to the first downlink device when the estimated downlink transmission time is less than the first estimated residual uplink transmission time.

26. The device of claim 22, wherein the computer-executable instructions executed by the at least one processor to cause to send the first downlink transmission to the first downlink device and the second downlink transmission to the second downlink device comprise computer-executable instructions to cause to send the first downlink transmission to the first downlink device and the second downlink transmission to the second downlink device when the estimated downlink transmission time is less than the estimated residual uplink transmission time.

27. The device of claim 21, further comprising a transceiver configured to transmit and receive wireless signals.

28. The device of claim 27, further comprising one or more antennas coupled to the transceiver.

29. A non-transitory computer-readable medium storing computer-executable instructions which when executed by one or more processors result in performing operations comprising:
receiving first downlink data from a first downlink device;
determining an estimated downlink transmission time for the first downlink device;
determining an estimated residual uplink transmission time; and
causing to send a first downlink transmission to the first downlink device based at least in part on the estimated residual uplink transmission time.

30. The non-transitory computer-readable medium of claim 29, further comprising causing to send a first downlink transmission to the first downlink device and a second downlink transmission to a second downlink device, based at least in part on the estimated residual uplink transmission time.

31. The non-transitory computer-readable medium of claim 29, wherein the estimated downlink transmission time for the first downlink device is determined based on a transmission configuration for the first downlink device.

32. The non-transitory computer-readable medium of claim 31, wherein the transmission configuration for the first downlink device comprises at least one of a transmit power and a modulation and coding scheme (MCS).

33. The non-transitory computer-readable medium device of claim 29, wherein causing to send the first downlink transmission to the first downlink device, comprises causing to send the first downlink transmission to the first downlink device when the estimated downlink transmission time is less than the estimated residual uplink transmission time.

34. The non-transitory computer-readable medium of claim 30, wherein causing to send the first downlink transmission to the first downlink device and the second downlink transmission to the second downlink device comprises causing to send the first downlink transmission to the first downlink device and the second downlink transmission to the second downlink device when the estimated downlink transmission time is less than the estimated residual uplink transmission time.

35. A method comprising:
receiving first downlink data from a first downlink device;
determining an estimated downlink transmission time for the first downlink device;
determining an estimated residual uplink transmission time for a first uplink device; and
causing to send a first downlink transmission to the first downlink device based at least in part on the estimated residual uplink transmission time.

36. The method of claim 35, further comprising causing to send a first downlink transmission to the first downlink device and a second downlink transmission to a second downlink device, based at least in part on the estimated residual uplink transmission time.

37. The method of claim 35, wherein the estimated downlink transmission time for the first downlink device is determined based on a transmission configuration for the first downlink device.

38. The method of claim 35, wherein the transmission configuration for the first downlink device comprises at least one of a transmit power and a modulation and coding scheme (MCS).

39. The method of claim 35, wherein causing to send the first downlink transmission to the first downlink device, comprises causing to send the first downlink transmission to the first downlink device when the estimated downlink transmission time is less than the estimated residual uplink transmission time.

40. The method of claim 36, wherein causing to send the first downlink transmission to the first downlink device and the second downlink transmission to the second downlink device comprises causing to send the first downlink transmission to the first downlink device and the second downlink transmission to the second downlink device when the estimated downlink transmission time is less than the estimated residual uplink transmission time.
